(19) United States
(12) Patent Application Publication
(10) Pub. No.: US 2021/0215831 A1
(43) Pub. Date: Jul. 15, 2021

(54) POSITIONING APPARATUS AND POSITIONING METHOD

(71) Applicant: SONY CORPORATION, TOKYO (JP)

(72) Inventor: HARUTO TAKEDA, TOKYO (JP)

(21) Appl. No.: 17/250,677

(22) PCT Filed: Aug. 15, 2019
(86) PCT No.: PCT/JP2019/032014

§ 371 Date: Feb. 18, 2021

Related U.S. Application Data
(60) Provisional application No. 62/723,977, filed on Aug. 28, 2018.

(51) Int. Cl. G01S 19/43; G01S 19/36

(52) U.S. Cl. CPC G01S 19/43; G01S 19/36

(57) ABSTRACT

The present disclosure relates to a positioning apparatus and a positioning method that make it possible to achieve a position measurement with a high degree of accuracy at low operating costs by using a small, lightweight, inexpensive GPS antenna and an IMU. An incident angle at which a carrier enters a GPS antenna is detected in global coordinates, and a posture of the GPS antenna is detected by the IMU in the global coordinates. On the basis of the posture, the incident angle at which the carrier enters the GPS antenna and being represented by the global coordinates is converted into the incident angle in local coordinates using a rotation matrix depending on the posture. On the basis of the incident angle in the local coordinates, an azimuth angle and an elevation angle are specified to obtain a phase difference based on a corresponding PCV, and a PCV correction value is calculated from the phase difference. A carrier phase is corrected using the calculated PCV correction value, and a position is measured. The present disclosure is applicable to a positioning apparatus.

### TECHNICAL FIELD

The present disclosure relates to a positioning apparatus and a positioning method, and, in particularly, to a positioning apparatus and a positioning method that make it possible to perform a position measurement with a high degree of accuracy at low operating costs.

### BACKGROUND ART

An aerial surveying technology using an air photo signal has been proposed.

In this aerial surveying technology, an accurately aligned air photo signal is placed in a target region, the target region is divided into specified regions from the air using, for example, a drone to perform image-capturing for each specified region, and the captured division images are stitched together using the air photo signals in the captured division images as references. This results in reproducing the target region in the form of a three-dimensional model.

In this case, there is a need to perform an position measurement with a high degree of accuracy using a global positioning system (GPS) antenna to place each air photo signal.

When the position measurement with a high degree of accuracy using a GPS antenna is performed, there is a need to correct for a variation depending on an azimuth angle and an elevation angle, the variation being a variation in a phase of a carrier from a satellite. Further, there is a need to use a large, expensive surveying antenna that is in a horizontally stationary state and has the characteristics of exhibiting an isotropic phase difference in which there is no difference in a YAW direction (an azimuth direction).

Thus, it is conceivable to perform a position measurement using a small, lightweight, relatively inexpensive GPS antenna. When a small, lightweight, relatively inexpensive GPS antenna is used, there is a need to measure a variation in carrier phase in advance to correct a carrier phase of a GPS signal. In order to utilize such correction, it is necessary that a GPS antenna be horizontal and oriented northward to be used by being aligned with coordinate axes of the surface of the earth.

Thus, a technology has been proposed that uses an inertial measurement unit (IMU) in combination with a small GPS antenna to perform a position measurement with a high degree of accuracy using a small, lightweight, relatively inexpensive GPS antenna (see Patent Literature 1).

### CITATION LIST

### Patent Literature

Patent Literature 1: US Patent Application Laid-open No. 2015-0019129

### DISCLOSURE OF INVENTION

### Technical Problem

However, in the technology disclosed in Patent Literature 1, there is a need to perform measurement while moving a GPS antenna and an IMU horizontally. This results in generating operating costs.

The present disclosure has been made in view of the circumstances described above, and, in particular, the present disclosure achieves a position measurement with a high degree of accuracy at low operating costs by using a small, lightweight, inexpensive GPS antenna and an IMU.

### Solution to Problem

A positioning apparatus according to an aspect of the present disclosure is a positioning apparatus that includes an antenna that receives a carrier from a satellite; a position measurement section that measures a position on the earth on the basis of a carrier phase that is a phase of the received carrier; and a correction value calculator that calculates a correction value used to correct for a variation caused in the carrier phase according to an incident angle at which the carrier enters the antenna, the position measurement section correcting for the variation caused in the carrier phase using the correction value calculated by the correction value calculator, the position measurement section measuring the position on the earth on the basis of the carrier phase resulting from the correction.

A positioning method according to an aspect of the present disclosure is a positioning method that includes measuring a position on the earth on the basis of a carrier phase that is a phase of a carrier received by an antenna that receives the carrier from a satellite; and calculating a correction value used to correct for a variation caused in the carrier phase according to an incident angle at which the carrier enters the antenna, the measuring the position including correcting for the variation caused in the carrier phase using the correction value calculated by the calculating the correction value, and measuring the position on the earth on the basis of the carrier phase resulting from the correction.

In an aspect of the present disclosure, a position on the earth is measured on the basis of a carrier phase that is a phase of a carrier received by an antenna that receives the carrier from a satellite, a correction value is calculated that is used to correct for a variation caused in the carrier phase according to an incident angle at which the carrier enters the antenna, the variation caused in the carrier phase is calculated for using the correction value calculated by the calculating the correction value, and the position on the earth is measured on the basis of the carrier phase resulting from the correction.

### BRIEF DESCRIPTION OF DRAWINGS

FIG. 1 is a diagram describing a PCV.

FIG. 2 illustrates a configuration example of a positioning apparatus of the present disclosure.

FIG. 3 is a diagram describing global coordinates.

FIG. 4 is a diagram describing local coordinates.

FIG. 5 is a diagram describing a difference in bias variation between a professional-use IMU and a consumer IMU.

FIG. 6 is a diagram describing PCV-characteristics information.

FIG. 7 is a flowchart illustrating positioning processing.

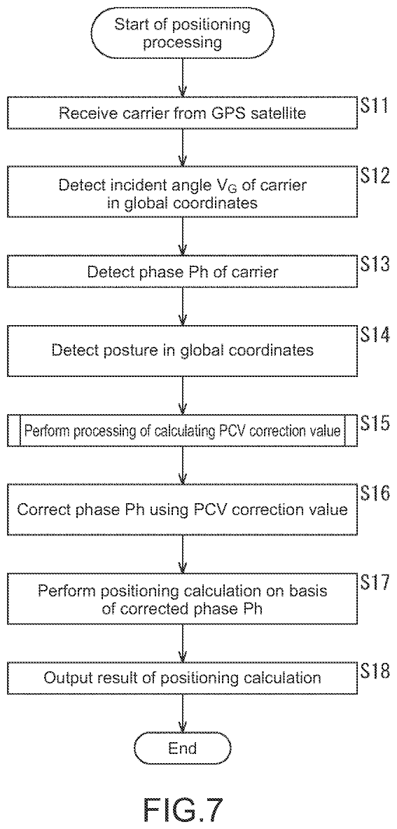

FIG. 8 is a flowchart illustrating PCV-correction-value calculation processing.

FIG. 9 illustrates a configuration example of a general-purpose personal computer.

### MODE(S) FOR CARRYING OUT THE INVENTION

Favorable embodiments of the present disclosure will be described in detail with reference to the accompanying drawings. Note that, in the specification and the drawings, components having substantially the same functional configuration are denoted by the same reference numeral to omit a repetitive description.

Embodiments for carrying out the present technology are described below. The description is made in the following order.
1. Outline of Disclosure
2. Favorable Embodiment
3. Example in Which Series of Processes is Performed Using Software

<<1. Outline of Disclosure>>

The present disclosure achieves a position measurement with a high degree of accuracy at low operating costs by using a small, inexpensive GPS antenna and an IMU.

In general, a position measurement using a GPS antenna is performed by tracking a signal that enters an antenna from a GPS satellite and by counting a phase of the signal. This phase is generally referred to as a carrier phase or an accumulated A (delta) range. Note that the phase is hereinafter referred to as a carrier phase.

The carrier phase corresponds to a distance between a transmission antenna that transmits a signal from a satellite and a reception antenna (GPS antenna) of a receiver.

In other words, a change in a position of a GPS antenna relative to a satellite is measured as a change in a phase of a carrier to be tracked, and a position measurement is performed on the basis of information regarding distances from a plurality of satellites that each correspond to the change in the carrier phase.

The receiver simultaneously supplements signals from a plurality of satellites. Due to the shape and the electrical characteristics of a GPS antenna, a variation is caused in carrier phase upon performing conversion into a distance, according to an incident angle (an azimuth angle and an elevation angle as viewed from a coordinate system of the GPS antenna). This variation is generally referred to as a phase center variation (PCV).

Typically, a surveying antenna is designed to have the isotropic characteristics such that there is a small variation (PCV) (such that superior PCV characteristics are obtained). However, a patch antenna and a helical antenna that are small and lightweight antennas may exhibit a great variation (may have inferior PCV characteristics).

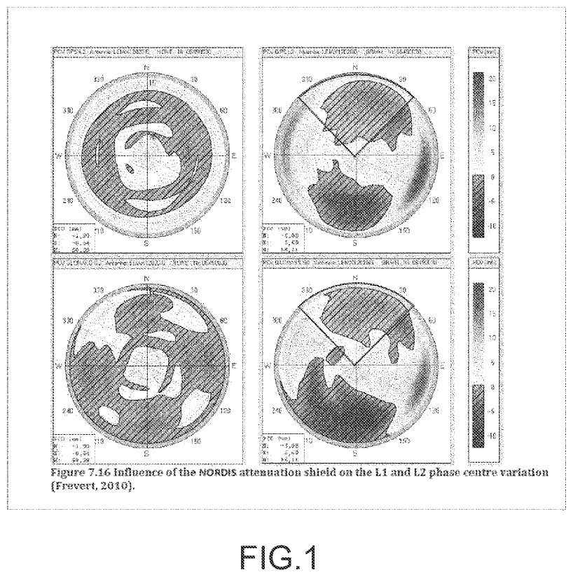

For example, as illustrated in FIG. 1, the PCV characteristics are represented as a distribution of a magnitude of a variation depending on the azimuth angle.

The PCV characteristics illustrated in an upper portion and the PCV characteristics illustrated in a lower portion on the left in FIG. 1 are both PCV characteristics of a large, relatively expensive GPS antenna having superior PCV characteristics. The PCV characteristics illustrated in the upper portion and the PCV characteristics illustrated in the lower portion on the right in FIG. 1 are both PCV characteristics of a small, relatively inexpensive GPS antenna having inferior PCV characteristics.

In other words, as illustrated on the left in FIG. 1, the PCV characteristics of a large, relatively expensive GPS antenna exhibit a relatively small variation with respect to a change in azimuth angle. As illustrated on the right in FIG. 1, the PCV characteristics of a small, relatively inexpensive GPS antenna exhibit a relatively great variation with respect to the change in azimuth angle.

When a position measurement is performed using a small, lightweight GPS antenna, there is a need to perform correction in consideration of an effect provided by a variation in carrier phase depending on an elevation angle and an azimuth angle for a direction in which a carrier enters the GPS antenna from a satellite, since the GPS antenna generally has inferior PCV characteristics, also as illustrated in FIG. 1.

Thus, in the present disclosure, an IMU is used in combination with a small, lightweight GPS antenna to obtain an incident angle (an elevation angle and an azimuth angle) of a signal from a satellite in global coordinates, and the incident angle in the global coordinates is converted into an incident angle in local coordinates based on the GPS antenna on the basis of information regarding a posture obtained using the IMU. Then, a correction value is obtained on the basis of the PCV characteristics obtained in advance for each incident angle in specified local coordinates to correct for an effect related to a variation in carrier phase. Accordingly, a position measurement is performed.

This makes it possible to perform a position measurement with a high degree of accuracy while reducing costs for a relatively heavy workload such as determination of the position of a GPS antenna upon performing a position measurement using a small, lightweight GPS antenna and an IMU.

<<2. Favorable Embodiment>>

<Configuration Example of Positioning Apparatus>

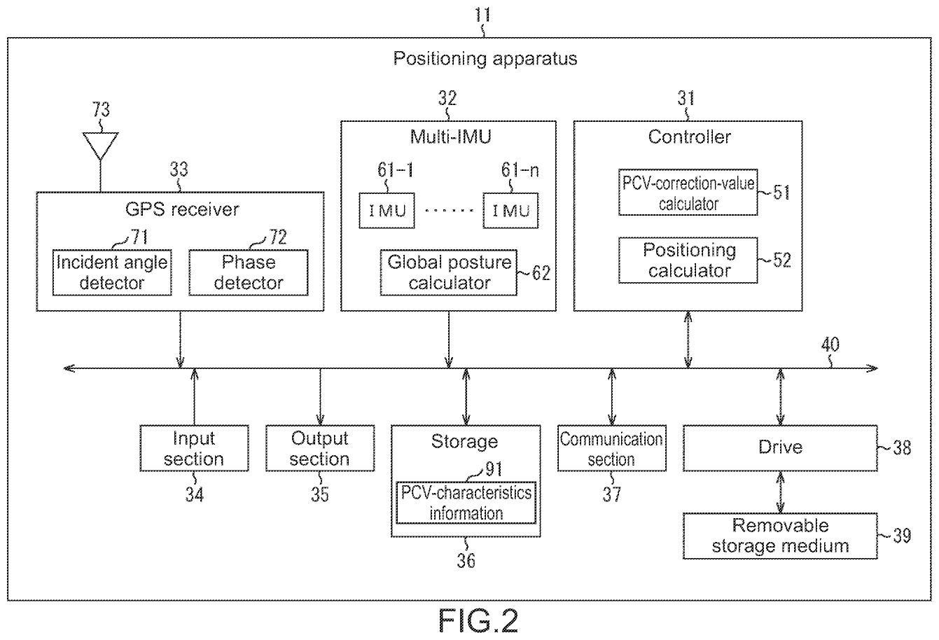

Next, a configuration example of a positioning apparatus to which the technology of the present disclosure is applied is described with reference to a block diagram of FIG. 2.

A positioning apparatus 11 illustrated in FIG. 2 includes a controller 31, a multi-IMU 32, a GPS receiver 33, an input section 34, an output section 35, a storage 36, a communication section 37, a drive 38, and a removable storage medium 39. These components of the positioning apparatus are connected to each other via a bus 40, and are capable of transmitting and receiving data and a program.

The controller 31 includes a processor and a memory, and controls an overall operation of the positioning apparatus 11. Further, the controller 31 includes a PCV-correction-value calculator 51 and a positioning calculator 52.

Using a rotation matrix R, the PCV-correction-value calculator 51 converts, into an incident angle (an elevation angle and an azimuth angle) in local coordinates, an incident angle (an elevation angle and an azimuth angle) of a carrier from a satellite in global coordinates, the carrier being supplied from the GPS receiver 33, the rotation matrix R being supplied from the multi-IMU 32. Then, on the basis of the obtained incident angle (the elevation angle and the azimuth angle) of the signal from the satellite in the local coordinates, the PCV-correction-value calculator 51 reads the corresponding PCV characteristics from PCV-characteristics information 91 measured in advance and stored in the storage 36, and calculates a PCV correction value.

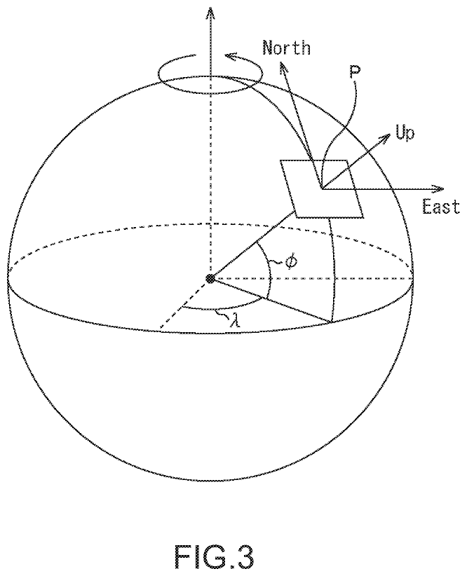

Here, the global coordinates are a local level frame (LLF) commonly used in satellite positioning on the earth. For example, as illustrated in FIG. 3, the global coordinate system is a coordinate system that defines a horizontal plane with latitude (east) and longitude (north), and is a coordinate system that is the right-hand coordinate system with a direction opposite to the vertical direction being used as a z-axis (up). The global coordinates are also referred to as east-north-up (ENU) coordinates since the global coordinates are coordinates at a position P of an antenna 73 in the GPS receiver 33 on the earth and are determined by a latitude direction (east), a longitude direction (north), and a z-axis direction (up) (a position of latitude φ and longitude λ in FIG. 3).

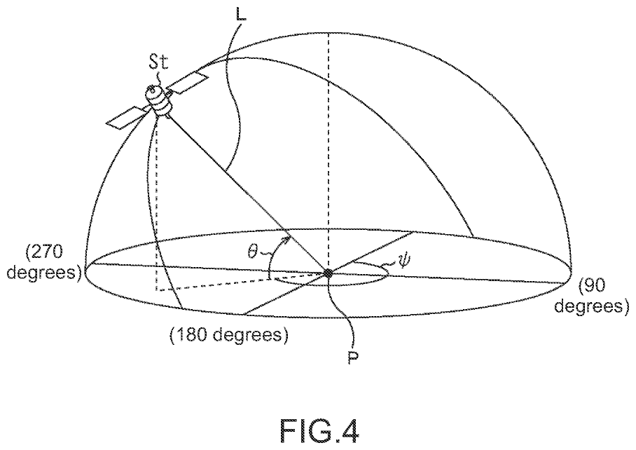

On the other hand, as illustrated in FIG. 4, the local coordinates are coordinates at a position P based on the antenna 73 in the GPS receiver 33 and are determined by an elevation angle θ and an azimuth angle ψ that represent an incident direction L of a carrier transmitted from a GPS satellite St.

The rotation matrix R is a matrix used to convert a posture of the antenna 73 that is represented by the global coordinates into a posture of the antenna 73 that is represented by the local coordinates.

On the basis of the PCV correction value calculated by the PCV-correction-value calculator 51, the positioning calculator 52 corrects for a variation caused in a phase of a carrier supplied from the GPS receiver 33. Further, on the basis of the corrected carrier phase, the positioning calculator 52 calculates a position and outputs the calculated position as a position measurement result.

On the basis of a result of detecting an acceleration and an angular velocity of the antenna 73, the multi-IMU 32 obtains a posture of the antenna 73 in the global coordinates, and outputs the obtained posture to the controller 31.

More specifically, the multi-IMU 32 includes a plurality of IMUs 61-1 to 61-n and a global posture calculator 62. Note that the IMUs 61-1 to 61-n are simply referred to as an IMU 61 when there is particularly no need to individually distinguish among the IMUs 61-1 to 61-n, and the same applies to a component other than the IMU 61.

Each of the plurality of IMUs 61-1 to 61-n includes, for example, an angular velocimeter such as a micro electro mechanical systems (MEMS) gyroscope sensor (hereinafter also simply referred to as a gyroscope), and an accelerometer such as a motion sensor. Each of the plurality of IMUs 61-1 to 61-n detects an angular velocity and an acceleration of the antenna 73 and outputs a result of the detection to the global posture calculator 62.

The global posture calculator 62 calculates a posture of the antenna 73 in the global coordinates from, for example, an average of the results of the detections respectively performed by the plurality of IMUs 61-1 to 61-n, and outputs information regarding the posture that is a calculation result to the controller 31.

The information regarding a posture of the antenna 73 can also be considered as a deviation of a posture of the antenna 73 in the global coordinate system, that is, a deviation of a rotational direction of the local coordinates based on the antenna 73 in the global coordinates. Thus, the global posture calculator 62 outputs the information regarding the posture of the antennas 73 in the global coordinates to the controller 31 in the form of the rotation matrix R used to convert the global coordinates into the local coordinates.

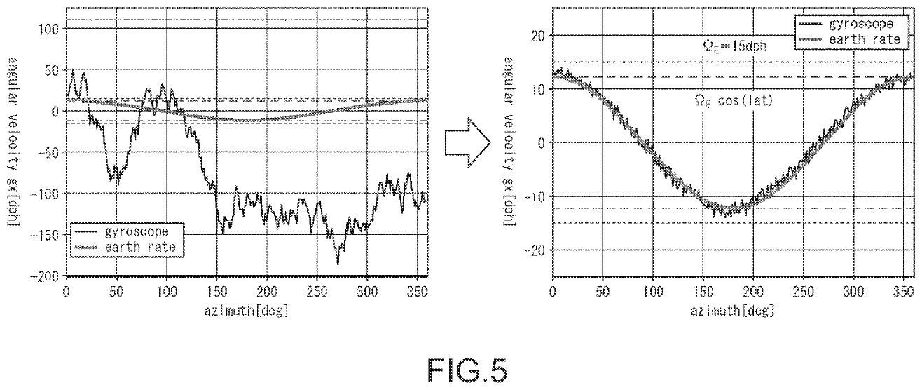

Each of the IMUs 61-1 to 61-n is a so-called consumer gyroscope such as a MEMS gyroscope that is a small, lightweight, relatively inexpensive gyroscope, and is a high-accuracy gyroscope. However, the IMU 61 exhibits a degree of accuracy lower than that of an expensive, so-called professional-use gyroscope, as illustrated in FIG. 5, and this results in being unable to detect an angular velocity related to the rotation of the earth.

FIG. 5 illustrates, on the left, a change in angular velocity gx with respect to azimuth that is detected using a small, lightweight, relatively inexpensive consumer gyroscope such as a MEMS gyroscope. FIG. 5 illustrates, on the right, a change in angular velocity gx with respect to azimuth that is detected using a relatively large, expensive professional-use gyroscope. Note that, in both of the examples in FIG. 5, the vertical axis represents the angular velocity gx and the horizontal axis represents the azimuth, where the gyroscopes are rotated in increments of one degree and immobilized for five minutes every time they are rotated (200 Hz). Further, a thin line (gyroscope) represents a result of detection performed by the gyroscope, and a thick line (earth rate) represents an actual angular velocity on the earth.

The angular velocity measured on the earth includes an angular velocity related to the rotation of the earth (360 deg/day=15 dph). In the case of a professional-use gyroscope, a bias variation due to noise is small. This results in performing a faithful measurement with respect to an actual angular velocity on the earth, and thus in relatively faithfully showing a change in angular velocity with respect to an azimuth angle depending on the rotation of the earth, as illustrated on the right in FIG. 5.

On the other hand, in the case of a low-accuracy consumer gyroscope such as a MEMS gyroscope, a bias variation due to noise is great. This results in being unable to perform a faithful measurement with respect to the actual angular velocity on the earth, and thus in not showing the change in angular velocity with respect to an azimuth angle depending on the rotation of the earth, as illustrated on the left in FIG. 5.

Thus, the present disclosure uses a plurality of IMUs 61 in combination to achieve the so-called multi-IMU 33, each of the plurality of IMUs 61 including, for example, a so-called consumer gyroscope that is small, lightweight, and relatively inexpensive. Then, a plurality of angular velocities is averaged to reduce a bias variation due to noise, although the plurality of angular velocities is results of detections of an angular velocity that are respectively performed by the low-accuracy IMUs 61.

Note that, in the present embodiment, an example of suppressing a variation by averaging results of detections respectively performed by a plurality of IMUs 61 has been described, but a value other than the average may be used as long as the variation can be suppressed and as long as the results of the detections respectively performed by the plurality of IMUs 61 are used. For example, a median may be used.

The GPS receiver 33 receives a carrier from a GPS satellite, detects an incident angle of the carrier from the satellite in the global coordinates and a carrier phase, and outputs the incident angle and the carrier phase to the controller 31.

More specifically, the GPS receiver 33 includes an incident angle detector 71, a phase detector 72, and the antenna 73.

The incident angle detector 71 detects information regarding an incident angle, in the global coordinate system, at which a signal carried by a carrier from a GPS satellite enters the antenna 73, and outputs the detected information to the controller 31.

The phase detector 72 detects a carrier phase that is a phase of a carrier from a GPS satellite, and outputs the detected carrier phase to the controller 31.

The input section 34 includes input devices such as a keyboard and a mouse that are used by a user to input an operation command, and supplies various input signals to the controller 31.

The output section 35 is controlled by the controller 31. The output section 35 outputs, to a display device (not illustrated), a supplied operation screen and a supplied image of a processing result, and displays them on the display device.

The storage 36 includes a hard disk drive (HDD), a solid state drive (SSD), a semiconductor memory, or the like. The storage 36 is controlled by the controller 31, and writes or reads various data including content data, and various programs.

Further, the storage 36 stores therein the PCV-characteristics information 91 including the PCV characteristics corresponding to a measurement result measured in advance, and supplies the PCV characteristics to the controller 31 as necessary.

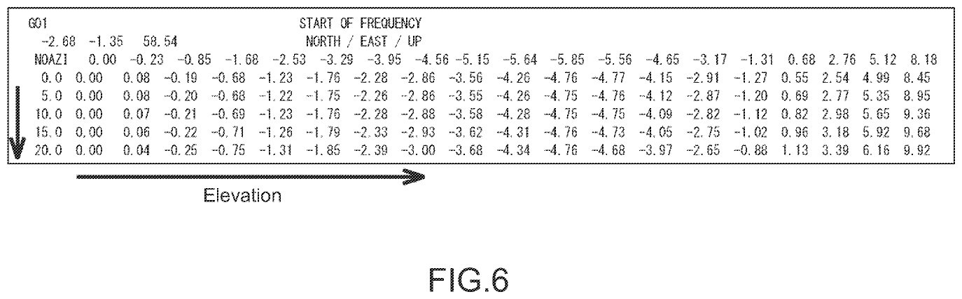

The PCV-characteristics information 91 is, for example, information illustrated in FIG. 6. The PCV-characteristics information 91 of FIG. 6 is an example of the ANTEX format, where, in each row, a phase difference for each azimuth angle is given in increments of five degrees of an elevation angle and in increments of ten degrees of an azimuth angle.

In the example of the ANTEX format of FIG. 6, a variation independent of an azimuth angle is given in the NOAZI row, and a variation depending on each elevation angle is given in the subsequent rows.

The PCV variation with an arbitrary elevation angle and an arbitrary azimuth angle can be calculated by performing interpolation using a table of the PCV-characteristics information 91 as illustrated in FIG. 6. A method for directly or indirectly calculating a correction value is known.

For a detailed calculation method, refer to, for example, http://sopac.ucsd.edu/input/processing/gamit/tables/igs08.atx.

The communication section 37 is controlled by the controller 31, and transmits/receives various data and programs to/from various apparatuses by wire (or wirelessly (not illustrated)) through a communication network as represented by, for example, a local area network (LAN).

The drive 38 reads data from and writes data into the removable storage medium 39 such as a magnetic disk (including a flexible disk), an optical disk (including a compact disc read-only memory (CD-ROM) and a digital versatile disc (DVD)), a magneto-optical disk (including a mini disc (MD)), or a semiconductor memory.

<Positioning Processing>

Next, positioning processing performed in the positioning apparatus 11 of FIG. 2 is described.

In Step S11, the GPS receiver 33 receives a signal from a GPS satellite via the antenna 73. Note that there exists a plurality of GPS satellites, and the GPS receiver 33 receives signals received by the antenna 73 from a plurality of GPS satellites at almost the same time. Thus, in subsequent processes, processes on a plurality of signals from a plurality of GPS satellites are approximately simultaneously performed in principle, unless otherwise specified. Here, a process performed on a signal from a single GPS satellite is described. However, of course, processes on signals from a plurality of GPS satellites are actually simultaneously performed.

In Step S12, the incident angle detector 71 performs a single positioning using a pseudorange or the like on the basis of a phase of a carrier received by the antenna 73, detects an incident angle (an elevation angle and an azimuth angle) V_{G} of the carrier from a satellite in the global coordinates in the global coordinate system, and outputs the detected incident angle to the controller 31.

In Step S13, the phase detector 72 of the GPS receiver 33 detects a phase of a signal carried by the carrier from the GPS satellite, and outputs the detected phase to the controller 31.

In Step S14, the global posture calculator 62 of the multi-IMU 32 detects a posture of the positioning apparatus 11 in the global coordinate system using results of detections of an acceleration and an angular velocity that are respectively performed by the IMUs 61-1 to 61-n, and outputs the detected posture to the controller 31 in the form of a rotation matrix R.

More specifically, the global posture calculator 62 of the multi-IMU 32 obtains an average of the results of the detections of an acceleration and an angular velocity that are respectively performed by the IMUs 61-1 to 61-n, and obtains a six-axis detection value (acceleration a (ax, ay, az), angular velocity ω (ωx, ωy, ωz)). A bias variation is suppressed by averaging results of detections performed by a plurality of IMUs 61-1 to 61-n, as described above.

Then, the global posture calculator 62 estimates the three parameters of roll, pitch, and yaw on the basis of the six-axis observation value.

Here, the gravitational acceleration and a speed of the rotation of the earth (an angular velocity of the rotation) are known, and are constraint conditions.

The global posture calculator 62 performs this conditional optimization calculation as an optimization calculation determined on the basis of characteristics of acceleration noise and gyro noise that are obtained from, for example, the specification of the IMU 61. For example, the global posture calculator 62 performs the conditional optimization calculation by solving Formula (1) indicated below.

[Formula 1]

\hat{R}=max P(a, ω|R) (1)

Here, R is a rotation matrix used to perform conversion from the global coordinate system to an antenna coordinate system, and a and ω are physical values of acceleration and an angular velocity that are measured by the multi-IMU 32.

Further, P(a,ω|R) is the probability that a detection value of the multi-IMU 32 is (a,ω) when the posture is R.

In other words, specifically, the probability P(a,ω|R) corresponds to the probability that the acceleration a and the angular velocity ω are detected by the multi-IMU 32 at the same time.

A calculation performed to obtain a posture (rotation matrix R) with which the probability P(a,ω|R) is maximized (max), can be performed using a general constrained optimization method.

A covariance matrix of a probability distribution can be determined using the noise characteristics provided as a specification of each IMU 61.

Further, as an equivalent calculation method, the calculation can also be formulated in the form of a weighted-difference minimization problem without using the probability.

In Step S15, the controller 31 performs processing of calculating a PCV correction value to calculate a PCV correction value.

<Processing of Calculating PCV Correction Value>

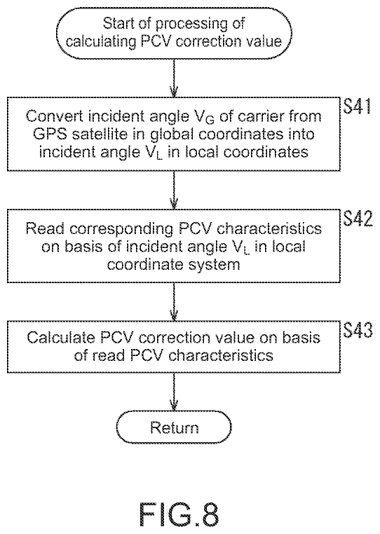

Here, the processing of calculating a PCV correction value is described with reference to a flowchart of FIG. 8.

In Step S41, the PCV-correction-value calculator 51 converts an incident angle (an elevation angle and an azimuth angle) V_{G} in the global coordinate system into an incident angle (an elevation angle and an azimuth angle) V_{L} in local coordinates by performing calculation represented by Formula (2) indicated below, using information regarding a posture of the positioning apparatus 11 in the global coordinates (rotation matrix R).

[Formula 2]

V_{L}=R·V_{G} (2)

In Step S42, the PCV-correction-value calculator 51 specifies an elevation angle θ and an azimuth angle ψ in the local coordinates on the basis of the incident angle V_{L} in the local coordinates using Formula (3) indicated below, and reads corresponding close values (phase differences) from among the PCV characteristics stored in the storage 36.

The incident angle V_{L} in the local coordinate system is represented by Formula (3) indicated below.

$$[ Formula 3 ]$$

$${V}_{L} = [ \begin{matrix}cos θ cos ψ \\ cos θ sin ψ \\ sin θ\end{matrix} ] \qquad ( 3 )$$

Here, θ is an elevation angle and ψ is an azimuth angle.

In Step S43, on the basis of the read close values (phase differences) regarding the PCV characteristics, the PCV-correction-value calculator 51 performs interpolation to calculate a PCV correction value that corresponds to the elevation angle θ and the azimuth angle ψ.

In other words, there is a possibility that there will not exist a PCV correction value that corresponds to an incident angle (an elevation angle θ and an azimuth angle ψ) for which a PCV correction value is actually necessary. The reason is that the PCV-characteristics information 91 is information that includes a phase difference (a PCV correction value) for each elevation angle θ and azimuth angle ψ, where the phase differences (PCV correction values) are discrete values, as described with reference to FIG. 6.

Thus, from among the PCV correction values registered in the PCV-characteristics information 91, the PCV-correction-value calculator 51 reads a plurality of close phase differences for the elevation angle θ and the azimuth angle ψ, the elevation angle θ and the azimuth angle ψ specifying an actually detected incident angle in the local coordinate system. Then, the PCV-correction-value calculator 51 performs interpolation to obtain an appropriate PCV correction value (phase difference) corresponding to the elevation angle θ and the azimuth angle ψ specifying the actually detected incident angle in the local coordinate system.

A PCV correction value corresponding to an incident angle of a carrier signal from a GPS satellite in the local coordinate system is calculated by performing the series of processes described above. Now return to the description of the flowchart of FIG. 5.

In Step S16, on the basis of the PCV correction value, the positioning calculator 52 corrects for a variation in a phase of a carrier received by the GPS receiver 33.

In Step S17, on the basis of the corrected carrier phase, the positioning calculator 52 performs positioning calculation to perform position measurement.

In Step S18, the positioning calculator 52 outputs a result of the position measurement.

The series of processes described above makes it possible to perform a position measurement in consideration of a PCV, using the small, lightweight, relatively inexpensive antenna 73 and an IMU. This results in there being no need for an operation such as strictly setting a direction upon installing the antenna 73, and thus in reducing operating costs. Consequently, it is possible to perform a highly accurate position measurement.

This makes it possible to place an air photo signal while performing a position measurement with a high degree of accuracy and reducing operating costs. This results in being able to improve the accuracy in placing an air photo signal.

<<3. Example in which Series of Processes is Performed Using Software>>

Note that the series of processes described above can be performed using hardware or software. When the series of processes is performed using software, a program included in the software is installed on a computer from a recording medium. Examples of the computer include a computer incorporated into dedicated hardware, and a computer such as a general-purpose personal computer that is capable of performing various functions by various programs being installed thereon.

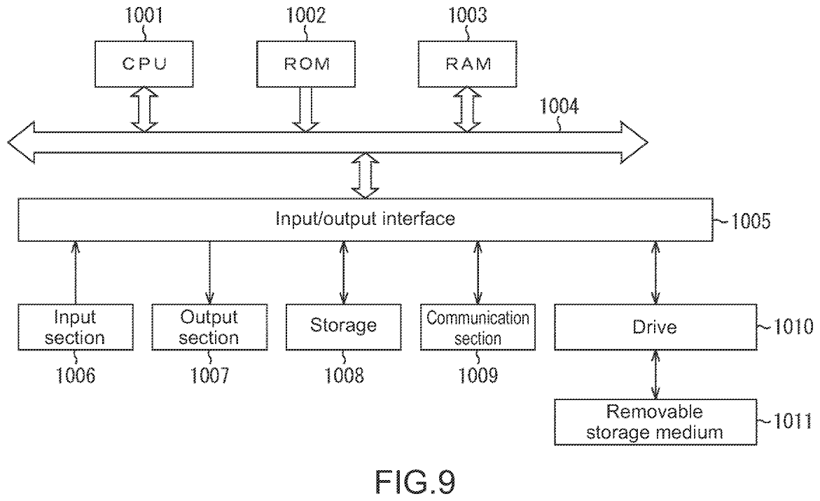

FIG. 9 illustrates a configuration example of a general-purpose computer. This personal computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

An input section 1006, an output section 1007, a storage 1008, and a communication section 1009 are connected to the input/output interface 1005. The input section 1006 includes input devices such as a keyboard and a mouse that are used by a user to input an operation command. The output section 1007 outputs a processing operation screen and an image of a processing result to a display device. The storage 1008 includes, for example, a hard disk drive that stores therein a program and various data. The communication section 1009 includes, for example, a local area network (LAN) adapter, and performs communication processing through a network as represented by the Internet. Further, a drive 1010 is connected to the input/output interface 1005. The drive 1010 reads data from and writes data into a removable storage medium 1011 such as a magnetic disk (including a flexible disk), an optical disk (including a compact disc read-only memory (CD-ROM) and a digital versatile disc (DVD)), a magneto-optical disk (including a mini disc (MD)), or a semiconductor memory.

The CPU 1001 performs various processes in accordance with a program stored in a ROM 1002, or in accordance with a program that is read from the removable storage medium 1011 such as a magnetic disk, an optical disk, a magneto-optical disk, or a semiconductor memory to be installed on the storage 1008, and is loaded into a RAM 1003 from the storage 1008. Data necessary for the CPU 1001 to perform various processes is also stored in the RAM 1003 as necessary.

In the computer having the configuration described above, the series of processes described above is performed by the CPU 1001 loading, for example, a program stored in the storage 1008 into the RAM 1003 and executing the program via the input/output interface 1005 and the bus 1004.

For example, the program executed by the computer (the CPU 1001) can be provided by being stored in the removable storage medium 1011 serving as, for example, a package medium. Further, the program can be provided via a wired or wireless transmission medium such as a local area network, the Internet, or digital satellite broadcasting.

In the computer, the program can be installed on the storage 1008 via the input/output interface 1005 by the removable storage medium 1011 being mounted on the drive 1010. Further, the program can be received by the communication section 1009 via the wired or wireless transmission medium to be installed on the storage 1008. Moreover, the program can be installed in advance on the ROM 1002 or the storage 1008.

Note that the program executed by the computer may be a program in which processes are chronologically performed in the order of the description herein, or may be a program in which processes are performed in parallel or a process is performed at a necessary timing such as a timing of calling.

Note that the function of the controller 31 of FIG. 2 is implemented by the CPU 1001 of FIG. 9.

Further, the system as used herein refers to a collection of a plurality of components (such as apparatuses and modules (parts)) and it does not matter whether all of the components are in a single housing. Thus, a plurality of apparatuses accommodated in separate housings and connected to one another via a network, and a single apparatus in which a plurality of modules is accommodated in a single housing are both systems.

Note that the embodiment of the present disclosure is not limited to the examples described above, and various modifications may be made thereto without departing from the scope of the present disclosure.

For example, the present disclosure may also have a configuration of cloud computing in which a single function is shared to be cooperatively processed by a plurality of apparatuses via a network.

Further, the respective steps described using the flowcharts described above may be shared to be performed by a plurality of apparatuses, in addition to being performed by a single apparatus.

Moreover, when a single step includes a plurality of processes, the plurality of processes included in the single step may be shared to be performed by a plurality of apparatuses, in addition to being performed by a single apparatus.

Note that the present technology may also take the following configurations.
<1> A positioning apparatus, including:

an antenna that receives a carrier from a satellite;

a position measurement section that measures a position on the earth on the basis of a carrier phase that is a phase of the received carrier; and

a correction value calculator that calculates a correction value used to correct for a variation caused in the carrier phase according to an incident angle at which the carrier enters the antenna, the position measurement section correcting for the variation caused in the carrier phase using the correction value calculated by the correction value calculator, the position measurement section measuring the position on the earth on the basis of the carrier phase resulting from the correction.
<2> The positioning apparatus according to <1>, in which

on the basis of the incident angle at which the carrier enters the antenna and being represented by local coordinates based on the antenna, the correction value calculator calculates the correction value used to correct for the variation caused in the carrier phase.
<3> The positioning apparatus according to <2>, further including

an incident angle detector that detects, in global coordinates, the incident angle at which the carrier enters the antenna, in which

the correction value calculator converts, into the incident angle represented by the local coordinates, the incident angle at which the carrier enters the antenna and being represented by the global coordinates, and

on the basis of the incident angle at which the carrier enters the antenna and being represented by the local coordinates, the correction value calculator calculates the correction value used to correct for the variation caused in the carrier phase.
<4> The positioning apparatus according to <3> further including

a posture detector that detects a posture of the antenna in the global coordinates, in which

on the basis of the posture detected by the posture detector, the correction value calculator converts, into the incident angle represented by the local coordinates, the incident angle at which the carrier enters the antenna and being represented by the global coordinates, and

on the basis of the incident angle at which the carrier enters the antenna and being represented by the local coordinates, the correction value calculator calculates the correction value used to correct for the variation caused in the carrier phase.
<5> The positioning apparatus according to <4>, in which

on the basis of a rotation matrix that corresponds to the posture detected by the posture detector, the correction value calculator converts, into the incident angle represented by the local coordinates, the incident angle at which the carrier enters the antenna and being represented by the global coordinates, and

on the basis of the incident angle at which the carrier enters the antenna and being represented by the local coordinates, the correction value calculator calculates the correction value used to correct for the variation caused in the carrier phase.
<6> The positioning apparatus according to <5>, in which

the incident angle at which the carrier enters the antenna and being represented by the local coordinates is specified by an azimuth angle and an elevation angle for the carrier that enters the antenna.
<7> The positioning apparatus according to <6>, further including

an antenna-characteristics-information storage that stores therein a phase difference in association with the azimuth angle and the elevation angle, the phase difference being a phase difference depending on the variation caused in the carrier phase according to the incident angle at which the carrier enters the antenna, in which

on the basis of the azimuth angle and the elevation angle that specify the incident angle at which the carrier enters the antenna and being represented by the local coordinates, the correction value calculator reads the corresponding phase difference from the antenna-characteristics-information storage, and calculates the correction value.
<8> The positioning apparatus according to <7>, in which

on the basis of the azimuth angle and the elevation angle that specify the incident angle at which the carrier enters the antenna and being represented by the local coordinates, the correction value calculator reads the corresponding phase differences from the antenna-characteristics-information storage, and performs interpolation to calculate the correction value.
<9> The positioning apparatus according to <4>, in which

the posture detector is an inertial measurement unit (IMU).
<10> The positioning apparatus according to <9>, in which

the posture detector is a multi-IMU that detects the posture on the basis of results of the detections respectively performed by a plurality of the IMUs.
<11> The positioning apparatus according to <10>, in which

the multi-IMU detects the posture on the basis of an average or a median of the results of the detections respectively performed by the plurality of the IMUs.
<12> The positioning apparatus according to <9>, in which

the multi-IMU includes a micro electro mechanical systems (MEMS) gyroscope sensor.
<13> The positioning apparatus according to any one of <1> to <12>, in which

the variation caused in the carrier phase according to the incident angle at which the carrier enters the antenna is phase center variability (PCV).
<14> A positioning method, including:

measuring a position on the earth on the basis of a carrier phase that is a phase of a carrier received by an antenna that receives the carrier from a satellite; and

calculating a correction value used to correct for a variation caused in the carrier phase according to an incident angle at which the carrier enters the antenna, the measuring the position including correcting for the variation caused in the carrier phase using the correction value calculated by the calculating the correction value, and measuring the position on the earth on the basis of the carrier phase resulting from the correction.

### REFERENCE SIGNS LIST

11 image-capturing apparatus
31 controller
32 multi-IMU
33 GPS receiver
34 input section
35 output section
36 storage
37 communication section
38 drive
39 removable storage medium
40 bus
51 PCV corrector
52 positioning calculator
61, 61-1 to 61-n IMU
62 global posture calculator
71 incident angle detector
72 phase detector
91 PCV-characteristics information

1. A positioning apparatus, comprising:
an antenna that receives a carrier from a satellite;
a position measurement section that measures a position on the earth on a basis of a carrier phase that is a phase of the received carrier; and
a correction value calculator that calculates a correction value used to correct for a variation caused in the carrier phase according to an incident angle at which the carrier enters the antenna, the position measurement section correcting for the variation caused in the carrier phase using the correction value calculated by the correction value calculator, the position measurement section measuring the position on the earth on a basis of the carrier phase resulting from the correction.

2. The positioning apparatus according to claim 1, wherein on a basis of the incident angle at which the carrier enters the antenna and being represented by local coordinates based on the antenna, the correction value calculator calculates the correction value used to correct for the variation caused in the carrier phase.

3. The positioning apparatus according to claim 2, further comprising an incident angle detector that detects, in global coordinates, the incident angle at which the carrier enters the antenna, wherein the correction value calculator converts, into the incident angle represented by the local coordinates, the incident angle at which the carrier enters the antenna and being represented by the global coordinates, and on the basis of the incident angle at which the carrier enters the antenna and being represented by the local coordinates, the correction value calculator calculates the correction value used to correct for the variation caused in the carrier phase.

4. The positioning apparatus according to claim 3, further comprising a posture detector that detects a posture of the antenna in the global coordinates, wherein on a basis of the posture detected by the posture detector, the correction value calculator converts, into the incident angle represented by the local coordinates, the incident angle at which the carrier enters the antenna and being represented by the global coordinates, and on the basis of the incident angle at which the carrier enters the antenna and being represented by the local coordinates, the correction value calculator calculates the correction value used to correct for the variation caused in the carrier phase.

5. The positioning apparatus according to claim 4, wherein on a basis of a rotation matrix that corresponds to the posture detected by the posture detector, the correction value calculator converts, into the incident angle represented by the local coordinates, the incident angle at which the carrier enters the antenna and being represented by the global coordinates, and on the basis of the incident angle at which the carrier enters the antenna and being represented by the local coordinates, the correction value calculator calculates the correction value used to correct for the variation caused in the carrier phase.

6. The positioning apparatus according to claim 5, wherein the incident angle at which the carrier enters the antenna and being represented by the local coordinates is specified by an azimuth angle and an elevation angle for the carrier that enters the antenna.

7. The positioning apparatus according to claim 6, further comprising an antenna-characteristics-information storage that stores therein a phase difference in association with the azimuth angle and the elevation angle, the phase difference being a phase difference depending on the variation caused in the carrier phase according to the incident angle at which the carrier enters the antenna, wherein on a basis of the azimuth angle and the elevation angle that specify the incident angle at which the carrier enters the antenna and being represented by the local coordinates, the correction value calculator reads the corresponding phase difference from the antenna-characteristics-information storage, and calculates the correction value.

8. The positioning apparatus according to claim 7, wherein on the basis of the azimuth angle and the elevation angle that specify the incident angle at which the carrier enters the antenna and being represented by the local coordinates, the correction value calculator reads the corresponding phase differences from the antenna-characteristics-information storage, and performs interpolation to calculate the correction value.

9. The positioning apparatus according to claim 4, wherein the posture detector is an inertial measurement unit (IMU).

10. The positioning apparatus according to claim 9, wherein the posture detector is a multi-IMU that detects the posture on a basis of results of the detections respectively performed by a plurality of the IMUs.

11. The positioning apparatus according to claim 10, wherein the multi-IMU detects the posture on a basis of an average or a median of the results of the detections respectively performed by the plurality of the IMUs.

12. The positioning apparatus according to claim 9, wherein the multi-IMU includes a micro electro mechanical systems (MEMS) gyroscope sensor.

13. The positioning apparatus according to claim 1, wherein the variation caused in the carrier phase according to the incident angle at which the carrier enters the antenna is phase center variability (PCV).

14. A positioning method, comprising:
measuring a position on the earth on a basis of a carrier phase that is a phase of a carrier received by an antenna that receives the carrier from a satellite; and
calculating a correction value used to correct for a variation caused in the carrier phase according to an incident angle at which the carrier enters the antenna, the measuring the position including correcting for the variation caused in the carrier phase using the correction value calculated by the calculating the correction value, and measuring the position on the earth on a basis of the carrier phase resulting from the correction.
